(19) United States
(12) Patent Application Publication
(10) Pub. No.: US 2002/0097357 A1
(43) Pub. Date: Jul. 25, 2002

(54) Coupled monolayer color reflective bistable liquid crystal display

(76) Inventors: Chun-Ming Huang, Taichung Hsien (TW); Hisu-Yuan Kuo, Tainan Hsien (TW); Yuan-Chieh Lin, Taichung Hsien (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/768,136

(22) Filed: Jan. 24, 2001

(51) Int. Cl. G02F 1/1335

(52) U.S. Cl. 349/113; 349/106

(57) ABSTRACT

A coupled monolayer color reflective bistable liquid crystal display including a lower glass substrate, a liquid crystal layer, an upper glass substrate, a number of intermedia and a frame gum. The lower and upper glass substrates respective have glass panels, conductive layers and alignment layers. The lower glass substrate further includes a reflector and a color-filter. The liquid crystal layer is laid between the upper and lower glass substrates. The liquid crystal layer has a number of cholesteric liquid crystal molecules in spiral form. A number of intermedia are arranged between the upper and lower glass substrates and parallelly positioned at the same space as the liquid crystal layer.

### BACKGROUND OF THE INVENTION

The present invention is related to a coupled monolayer color reflective bistable liquid crystal display, and more particularly to a liquid crystal display including a monolayer cholesteric liquid crystal layer. The voltage can be shut by two different ways to make the liquid crystal molecules are textured in two different stable states, whereby the reflection state of the incident light can be selected.

FIG. 6 shows basic structure of a conventional color reflective liquid crystal display in which red, green and blue panels 81, 82, 83 are stacked. A black absorbent panel 84 is laid under the bottom of the panels 81, 82, 83. By means of cooperation of the three panels 81, 82, 83 by different ways, at most eight colors can be displayed. The three panels 81, 82, 83 of such liquid crystal display are assembled by means of upper glass panels 811, 821, 831 and lower glass panels 812, 822, 832. Liquid crystal layers 813, 823, 833 are filled into the spaces between the glass panels. The colors of the three panels 81, 82, 83 will overlap each other so that the utilization ratio of light is reduced and the reflectivity of the panels 81, 82, 83 is lowered. (The green panel 82 is lowered to 31%, while the blue panel 83 is lowered to 38%.) As a result, the brightness of such liquid crystal display is decreased. Moreover, it is complicated and difficult to assemble and match the panels 81, 82, 83 with each other so that the manufacturing cost is relatively high and the ratio of defective products is higher. Furthermore, such liquid crystal display is composed of the three different colors of panels 81, 82, 83 which are assembled by means of the upper glass panels 811, 821, 831 and lower glass panels 812, 822, 832 and liquid crystal layers 813, 823, 833. Such liquid crystal display has a considerably thick thickness and heavy weight.

FIG. 7 shows another type of color reflective liquid crystal display in which a blue upper liquid crystal layer 92 is laid under the upper glass panel 91. A common substrate 93 is laid under the upper liquid crystal layer 92. A yellow lower liquid crystal layer 94 is laid under the common substrate 93. A lower glass panel 95 is laid under the lower liquid crystal layer 94. A block absorbent layer 96 is painted on the bottom of the lower glass panel 95. Conductive layers 911, 931, 951 and alignment layers 912, 932, 952 are respectively painted over the bottom face of the upper glass panel 91 and top face of the lower glass panel 95 and both top and bottom faces of the common substrate 93 so as to reduce the number of used glasses. However, in manufacturing procedure, the liquid crystal still must be filled at least twice. Therefore, it is still complicated and troublesome to manufacture such liquid crystal display and the production efficiency can be hardly promoted.

### SUMMARY OF THE INVENTION

It is therefore a primary object of the present invention to provide a coupled monolayer color reflective bistable liquid crystal display which includes cholesteric liquid crystal layer. The voltage can be shut by two different ways to arrange the liquid crystal molecules into two different stable states, whereby the original picture remains unchanged without being powered. Accordingly, the power is saved.

It is a further object of the present invention to provide the above coupled monolayer color reflective bistable liquid crystal display in which the components necessitating match are reduced so that the production efficiency can be promoted and the total weight of the liquid crystal display is reduced.

The present invention can be best understood through the following description and accompanying drawings wherein:

### BRIEF DESCRIPTION OF THE DRAWINGS

FIG. 1 is a sectional view showing the structure of the present invention;

FIG. 2 is a view showing the structure of the present invention, in which a voltage of 30 volts is applied to the liquid crystal molecules of the liquid crystal layer to make the incident light penetrative;

FIG. 3 is a view of the present invention, showing that when the voltage is fast shut, the liquid crystal molecules are parallel to the upper and lower glass substrates, whereby the incident light is reflected;

FIG. 4 is a view of the present invention, showing that when the voltage is slowly shut, the liquid crystal molecules are scattered between the upper and lower glass substrates, whereby the incident light is diffused;

FIG. 5 is a view of the present invention, showing one single pixel in a used state;

FIG. 6 is a sectional view showing the structure of a conventional color reflective liquid crystal display; and

FIG. 7 is a sectional view showing the structure of another type of conventional color reflective liquid crystal display.

### DETAILED DESCRIPTION OF THE PREFERRED EMBODIMENT

Please refer to FIGS. 1 to 5. The present invention includes:

a lower glass substrate 3 having a lower glass panel 31, a reflector 32 vapor-plated over the lower glass panel 31 and a color-filter 33 overlaying the reflector 32, the color-filter 33 being composed of a number of pixels 331, each pixel 331 being composed of a red block 332, a green block 333 and a blue block 334 which partially overlap each other and are arranged side by side, a conductive layer 34 (ITO) overlaying the color-filter 33, an alignment layer (PI) overlaying the conductive layer 34;

a liquid crystal layer 4 laid over the alignment layer 35 of the lower glass substrate 3, the liquid crystal layer 4 being cholesteric liquid crystal and composed of a number of liquid crystal molecules 41 which respectively form spiral structures and have a certain pitch P for reflecting short wavelength incident light, whereby when voltage is fast shut, the liquid crystal layer 4 presents a dark blue color;

an upper glass substrate 5 overlaying the liquid crystal layer 4, the upper glass substrate 5 having an uppermost transverse upper glass panel 51, an upper conductive layer 52 underlaying the upper glass panel 51 and an upper alignment layer 53 laid between the upper conductive layer 52 and the liquid crystal layer 4;

a number of intermedia 6 evenly distributed between the alignment layer 35 of the lower glass substrate 3 and the upper alignment layer 53 of the upper glass substrate 5 and bonded with the alignment layer 35 and the upper alignment layer 53, the intermedia 6 being parallelly positioned at the same space as the liquid crystal layer 4; and

a frame gum 7 laid along the edges of the upper glass substrate 5 and the lower glass substrate 3 to seal the edge of the liquid crystal layer 4.

It should be noted that the liquid crystal layer 4 being cholesteric liquid crystal which is characterized in that the liquid crystal molecules 41 have spiral structures for reflecting short wavelength incident light. This is preferred in the present invention. The pitch P of the liquid crystal molecules 41 is reduced. The arrangement of the liquid crystal molecules 41 causes deflected light so as to show visible color. Therefore, when using such liquid crystal layer-4, it is unnecessary to use a deflector and the liquid crystal layer 4 is able to selectively reflect incident light. The utilization ratio of the incident light is up to 50%. Moreover, without electric field action, the liquid crystal molecules 41 of the cholesteric liquid crystal have two different stable states of textures, depending on the shutting way of voltage as follows:

1. Fast shutting of voltage makes the liquid crystal molecules 41 planar textured between the upper glass substrate 5 and the lower glass substrate 3 to selectively reflect incident light. The wavelength of the reflected light is adjustable in accordance with the pitch P of the liquid crystal molecules 41.

2. Slowly shutting of voltage makes the liquid crystal molecules 41 focal conic textured between the upper glass substrate 5 and the lower glass substrate 3. The incident light travels between the liquid crystal molecules 41 in a scattering state and a milk white color is presented.

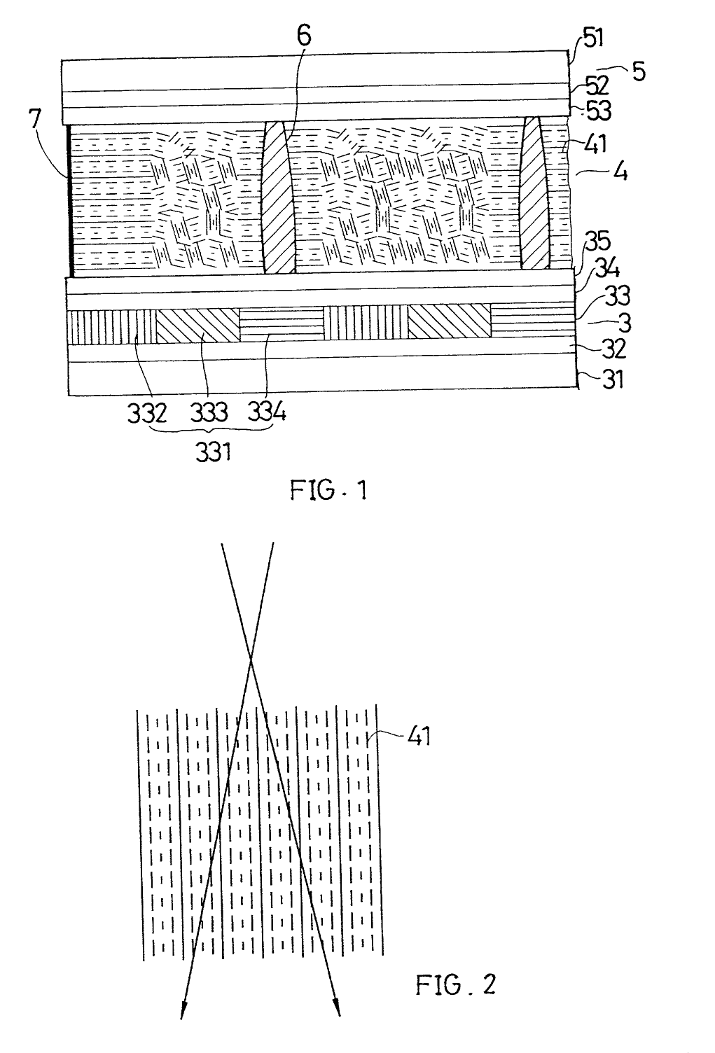

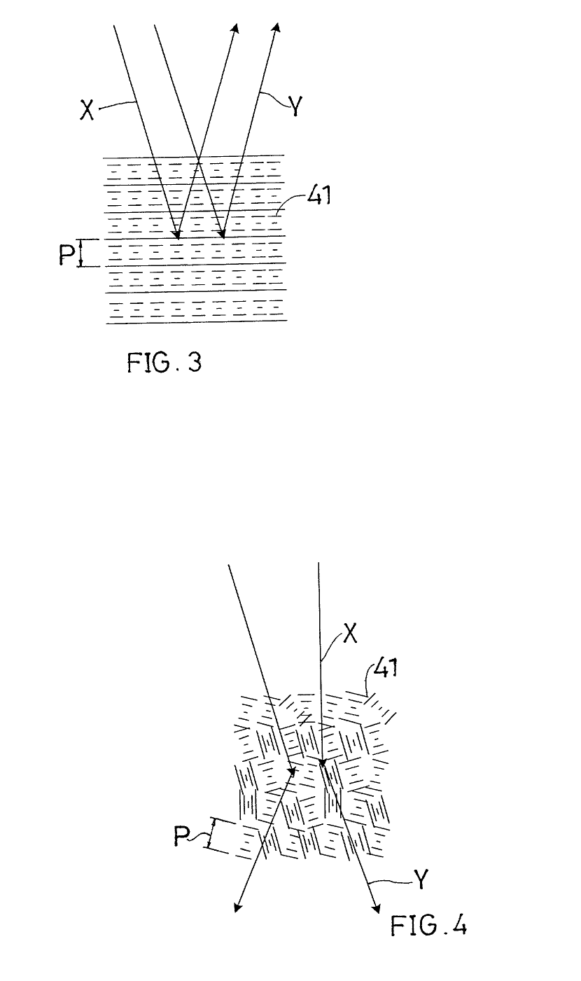

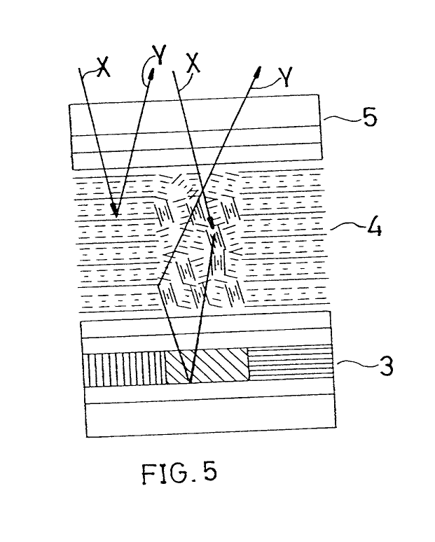

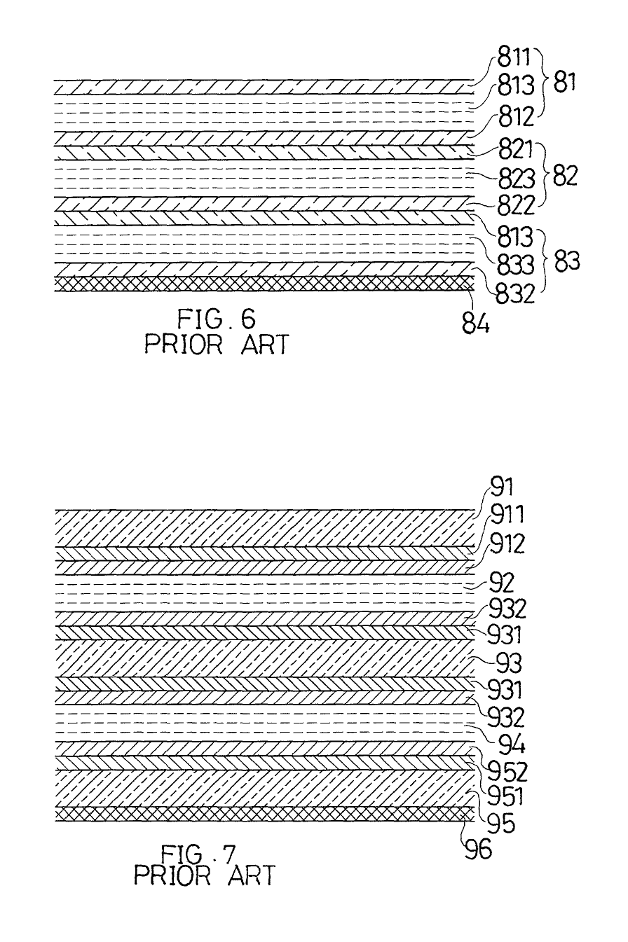

In use of the present invention, when driving the liquid crystal display, a voltage of about 30 volts is first applied to the liquid crystal layer 4 to make the liquid crystal molecules 41 of the liquid crystal layer 4 normal to the upper glass substrate 5 and the lower glass substrate 3 (as shown in FIG. 2). In the condition that the pitch P of the liquid crystal molecules 41 of the liquid crystal layer 4 is meaningly reduced, the voltage is fast or slowly shut according to the pre-shown figures or words. Fast shutting of voltage leads to a planar texture of the liquid crystal molecules 41. Under such circumstance, the incident light X downward passes through the upper glass panel 51, upper conductive layer 52 and upper alignment layer 53 of the upper glass substrate 5 into the liquid crystal layer 4. The liquid crystal molecules 41 of the liquid crystal layer 4 will reflect the incident light with short wavelength (as shown in FIG. 3), whereby the surface of the liquid crystal display will present a dark blue color which is sufficient to shade those colors of the color-filter 33 unnecessary to display. In addition, slowly shutting of voltage (as shown in FIG. 4) makes the incident light X downward passes through the upper glass panel 51, upper conductive layer 52 and upper alignment layer 53 of the upper glass substrate 5 into the liquid crystal layer 4. The liquid crystal molecules 41 of the liquid crystal layer 4 is in a scattering state so that when the incident light X is diffused by the liquid crystal molecules 41, a part of incident light X is able to downward pass through the liquid crystal layer 4 and pass through the alignment layer 35 and conductive layer 34 of the lower glass substrate 3 into the color-filter 33. Therefore, the colors of the red block 332, green block 333 or blue block 334 in the pixel 331 are blended. The incident light further reaches the reflector 32 to be reflected thereby and become emerging light Y The emerging light Y passes through the upper glass substrate 5 along a path different from that of the incident light X, enabling a user to see a predetermined color (as shown in FIG. 5).

When the voltage is shut by two different ways, the liquid crystal molecules 41 in the liquid crystal layer 4 exist in two different stable states, whereby the liquid crystal display can display predetermined pictures. Prior to being replaced by a next picture, the original picture remains unchanged without being powered. Accordingly, zero power is consumed, while the picture is maintained so that the cost for the power is saved and the using time of the battery is prolonged.

In addition, structurally, the present invention only includes the lower and upper glass substrates 3, 5 and the liquid crystal layer 4 sandwiched therebetween. Therefore, less components are stacked and the entire body has thinner thickness and lighter weight. This meets the requirements of light weight, thin thickness, short length, small volume of the modern photoelectronic products. Furthermore, in the manufacturing procedure of the present invention, only a step of filling of liquid crystal is needed. Also, only the lower and upper glass substrates 3, 5 and the liquid crystal layer 4 need to be matched. Therefore, the components necessitating match are less. This helps in solving the problem of matching of the components so that the production efficiency can be promoted.

The above embodiment is only used to illustrate the present invention, not intended to limit the scope thereof. Many modifications of the above embodiment can be made without departing from the spirit of the present invention.

What is claimed is:

1. A coupled monolayer color reflective bistable liquid crystal display comprising:
a lower glass substrate having a lower glass panel, a reflector overlaying the lower glass panel and a color-filter overlaying the reflector, the color-filter being composed of a number of pixels, each pixel being composed of a red block, a green block and a blue block which are arranged side by side, a conductive layer overlaying the color-filter, an alignment layer overlaying the conductive layer;
a liquid crystal layer laid over the alignment layer of the lower glass substrate, the liquid crystal layer being cholesteric liquid crystal and composed of a number of liquid crystal molecules;
an upper glass substrate overlaying the liquid crystal layer, the upper glass substrate having an uppermost transverse upper glass panel, an upper conductive layer underlaying the upper glass panel and an upper alignment layer laid between the upper conductive layer and the liquid crystal layer;
a number of intermedia evenly distributed between the alignment layer of the lower glass substrate and the upper alignment layer of the upper glass substrate and bonded with the alignment layer and the upper alignment layer, the intermedia being parallelly positioned at the same space as the liquid crystal layer; and
a frame gum laid along edges of the upper glass substrate and the lower glass substrate to seal the edge of the liquid crystal layer.

2. A coupled monolayer color reflective bistable liquid crystal display as claimed in claim 1, wherein the red block, green block and blue block of the pixel partially overlap each other.

3. A coupled monolayer color reflective bistable liquid crystal display as claimed in claim 1, wherein the liquid crystal molecules of the liquid crystal layer respectively form spiral structures and have a certain pitch.
